(19) United States
(12) Patent Application Publication
(10) Pub. No.: US 2009/0139140 A1
(43) Pub. Date: Jun. 4, 2009

(54) METHOD AND DEVICE TO GROW BULB-CROPS

(76) Inventor: Arnoldus Cornelis Jozef Ammerlaan, Enkhuizen (NL)

Correspondence Address: HOFFMANN & BARON, LLP, 6900 JERICHO TURNPIKE, SYOSSET, NY, 11791, US

(21) Appl. No.: 11/993,334

(22) PCT Filed: Jun. 21, 2006
(86) PCT No.: PCT/NL06/00304

§ 371 Date: Feb. 20, 2009

(30) Foreign Application Priority Data
Jun. 23, 2005 (NL) 1029321

(51) Int. Cl. A01G 9/10

(52) U.S. Cl. 47/64; 47/58.1 R

(57) ABSTRACT

The invention is related to a method and device to grow bulb-crops for Cut-flower-production, like tulip bulbs or daffodil-bulbs. The device is constructed with a growing substrate, like a layer of mineral wool, including supportive means to position the bulbs to grow upright in the substrate. The device of substrate has gabs and or channels under the bulb, to create rooting-chambers or root-channels, to store and guide the roots of the bulbs. The invention shows also a method to grow commercial flower bulb crops.

The invention is related to a design to grow bulb crops

It is known that bulb crops, like tulip-bulbs, daffodil-bulbs and others, can be grown in soil or boxes with potting-soil. In this situation the (potting) soil needs to contain fertilizer, water and air to perform as a substrate. Due to the open, soil, structure, good rooting is possible Due to the root growth, the bulbs can press themselves up into the substrate or in the air above the substrate Due to this the bulbs and stems, growing out of these bulbs can become instable. This can result in hooked stems or horizontal dropping bulbs and/or stems. To prevent this, planted bulbs in soil or potting soil are covered with sand, soil, foam-blocks of polystyrene or other supportive means. A disadvantage of this method, to grow in potting soil in greenhouses, is the use of natural resources like peat and soil by the potting soil industry. This damages the natural environment in specific geographical areas. Also, the used (potting) soil can contain additional fertilizers, chemicals and plant-parts that can increase pollution

The alternative method to this substrate is the so-called “(floating) water” system In this the bulbs can be tightened in an elastic model above a water-reservoir, as published in NL 1010950, also the bulbs can be pinched on specially designed pins in the water reservoir, as described in NL 9301407, the so called “prick-tray” Due to these specific devices the bulb-crop keeps in a stable vertical position. The water-reservoir supplies the bulb-crop with fertilizers, water and act therefore as substrate. A disadvantage of this device is that the pins or the tightening treatment mostly damages the bulbs. When the water in this device is not refreshed frequently, “dead” water can be the result (no oxygen in the water) After use, the soil-boxes and “prik-trays” are disinfected to reduce fungi and bacterial infection with future crops. This method increases the costs and brings additional pollution to the environment.

The invention brings a new device to grow bulb-crops with reducing a part of the disadvantages of the devices used today and using the advantages of the devices used today. Therefore the device has specific means as described in conclusion 1.

The use of mineral wool as substrate/growing medium brings many advantages. Mineral wool has a good absorbing capacity, for water, air, fertilizers and other materials like fungicides, anti-bacterial chemicals and disinfection chemicals. Above all, mineral wool (in opposite to for example hydro-culture, as described in NL 9301407) is supportive to a good division of water, fertilizers, oxygen and hard material, resulting in a substrate of high quality. This is a stable quality, due to the fact that mineral wool has a stable production method and raw material. The division of the hard material, water and air can be made by irrigation of the mineral wool. This results in optimal growing circumstances for the roots, with a high humidity, enough air/oxygen, and supply of fertilizer and disinfection chemicals for various diseases and infections. Mineral wool is re-useable and can be easily recycled, and therefore environmental friendly. Mineral wool can be easily modeled and is easy to handle. It can be formed to almost every shape and size. Length, width and height can be modeled to the logistical needs in the production location or systems used. Therefore the growing medium can be used in various, already today used, growing systems.

The gabs in the mineral wool create special rooting-areas where the roots can develop freely, without pushing up the bulbs. Due to this the bulbs can stay in a stable vertical position. The roots can be fixed near or in the substrate or growing medium, or a combination of both, and take food, water and oxygen from the substrate or growing substrate. Also these fixed roots can result in an even more stable position of the bulb.

The gabs can be produced in a model and position to guide the root development in a specific direction. This prevents mixing of roots from other bulbs without splitting the growing resources like water, oxygen and fertilizer. Strong root growing and mixing can have a negative effect on the harvest and reduction of quality due to root damage. The quantity of growing substrate, which stick to the roots during harvest will be limited, which results in a reduced part of this material in the second part of harvesting process. By using specific models of the gabs and guiding the roots, and in case separating the roots, the chance of infections can be reduced when infected bulbs are used in the bulb-crop.

A specific design of this device can result in gabs/channels which are open at the top and bottom of the mineral wool substrate The advantage is that an oversupply of water can easily leave the substrate This type of design has also the advantage that the mineral wool can easily piled up after planting. The gabs of the upper layer give space to the top of the bulb-crop of the layer underneath. The alternative is that the rooting channel is closed on the bottom side.

The supportive means bring and hold the bulbs in the preferred position. Also, due to special, optimal design, the maximum possible units/bulbs per area can be pre-designed and used

One aspect of the invention presents the supportive means as a traditional pin-structure. Alternative can be a supportive means by tightening means as described in Conclusion 7

Such a device is useful to secure the bulb-position in the growing substrate easily. The surrounding material will transform and tighten the bulb. This transformation will result in a close contact between the bulb and the wall of substrate around for optimal support. The gabs in the substrate have the advantage that the people working with this system will not be wounded, like with the “priktray” Above all, this system will hardly not damage the bulb at all.

Depending on the bulb-crop, especially the specie, the size and the form and spacing of the gabs can be optimised. In this way the gabs can be presented as separate wholes or ridges. This way is also applicable for the gabs in the growing substrate. The gabs can be presented in a specific range or pattern, and distance.

With a device according to the invention, the bulb-crop can be harvested in several shifts. In this case the supportive means, the rooting chambers and root-channels bring enough support for the remaining bulbs and their roots, so they do not drop or fall over or bend over.

Another aspect of the invention shows the change-over between the various gabs These change-over can be specially designed in, rounded, flat or declining forms The change-over supports the tightened bulbs even better with a stable support and an increased contact surface, which improves the contact with the surrounding humid substrate, especially when the substrate is wet.

The mineral wool can be pressed till a specific weight per m³. This influences the strength of the growing substrate. Other strengthen methods can be realised by the concentration of the fibres which make the growing substrate, the carrier which supports the growing substrate (plastic box) and/or the weight of the growing substrate including water, bulbs and fertilizer (gravitation)

The invention also has to do with a method to raise bulb-crops. In this, the actions like planting and storage and the treatment for rooting and forcing the bulbs can easily be separated in location and time, with the method and device of this invention In this case the need for controlled storage can be reduced dramatically. The growing substrate can be stored dry, including bulbs, and watered on a special moment Also special bulb-treatments, for example root-development, the leaf-development and flower-bud-development or a controlled “stop” in a development and storage can take place in the (dry) growing medium. This can result in a prefabricated load of planted bulbs for forcing flower-bulbs. Just after watering the growing substrate, the bulbs will be activated and the growth and other processes will take place.

The above described method and device can be used with all kinds of growing substrates, which have the stability and, after watering, the separation of water, fertilizer and air Especially in this case are other growing substrates with water-absorbing characteristics, like special designed foam blocks, oasis, rubber-dirt and natural fibres or combinations of fibres and other material, like coco-peat, hemp-fibres, stinging-nettle-fibres or other natural fibres which can be used as replacement for mineral wool.

In the other additional-conclusions, other advantageous designs of the device and method are described. To clarify the invention the design-examples of the invention and the use of it will be supported by drawings. In this presents:

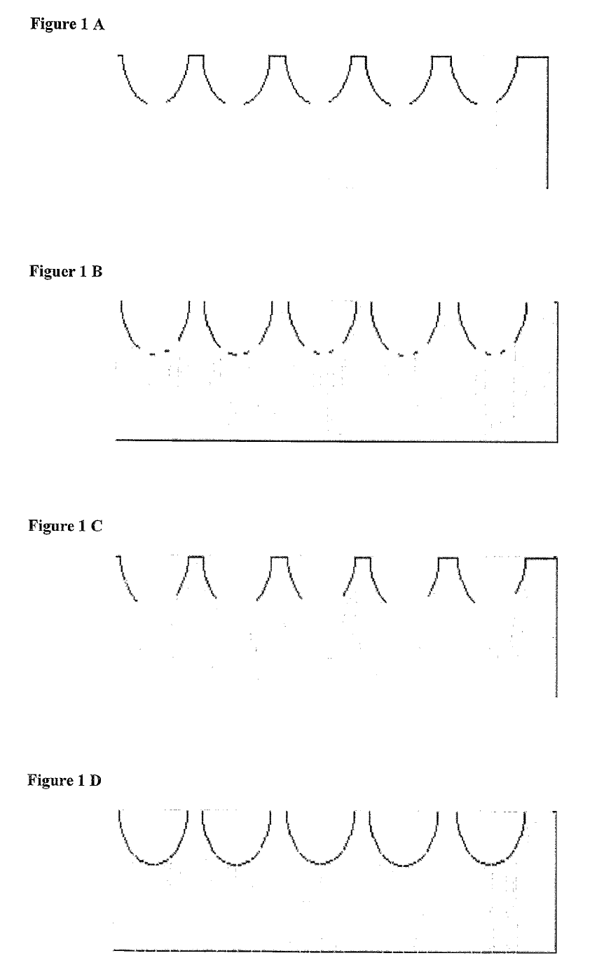

FIG. 1A-D is a cross section with 4 designed samples of the device according to the invention, which show the rooting chambers in the growing substrate in various forms.

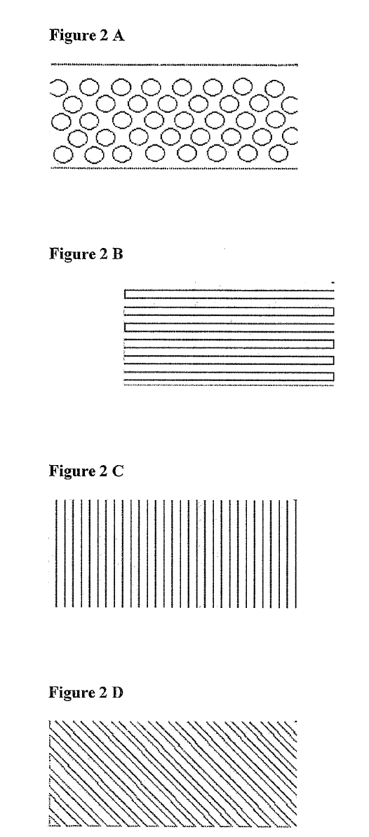

FIG. 2A-D is a view from above of 4 designed samples, with additional supporting wholes to be filled with bulbs, where the wholes are presented as round quiver-form wholes, ridges in the length, ridges in the width and diagonal ridges.

FIG. 3 is a close-up of fifth design-examples of the invention, including a bulb-crop.

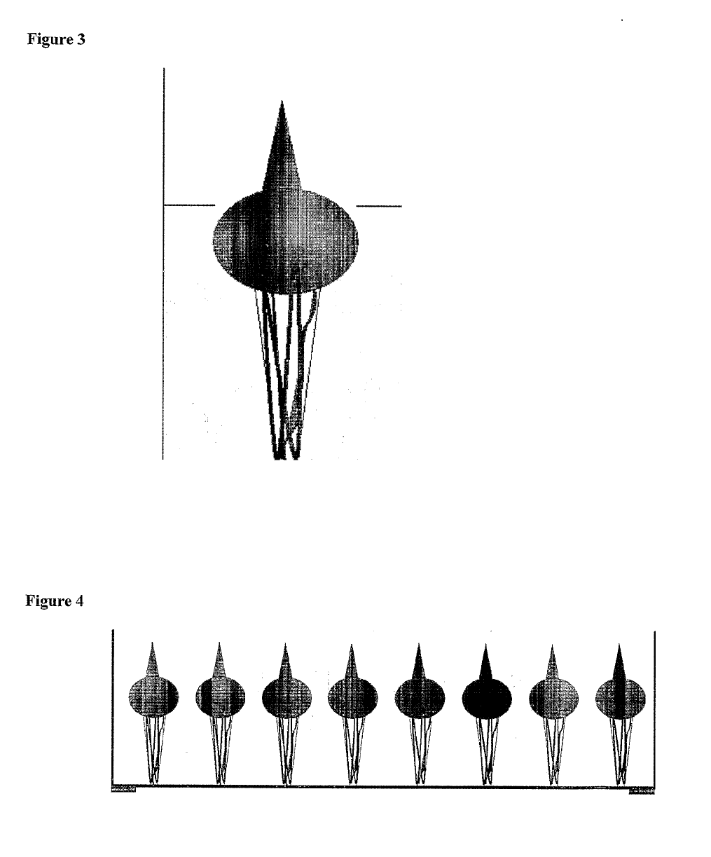

FIG. 4 is a cross section of a design of the invention in a special designed bulb-forcing box and bulbs.

FIG. 5 in cross section according the invention with two designed layers of substrate in storage position above each other.

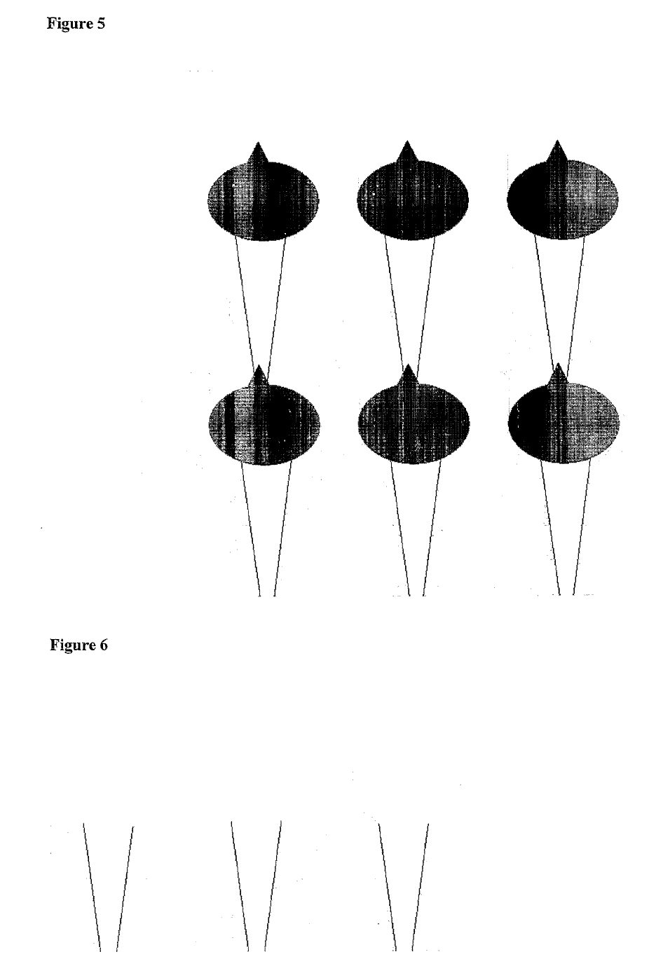

FIG. 6 in a cross section according the invention with various gab-models, for the fixation and tightening of various bulb-crops.

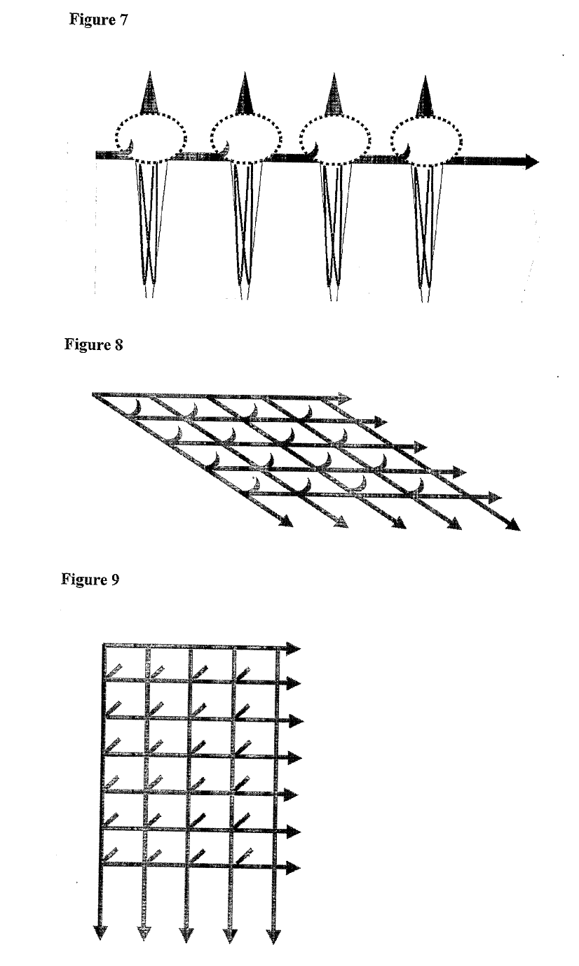

FIG. 7 in a cross section according the invention with various alternatives supporting means.

FIG. 8 is a close-up of various alternatives supporting means as in FIG. 7.

FIG. 9 is another alternative design of supporting means according the invention.

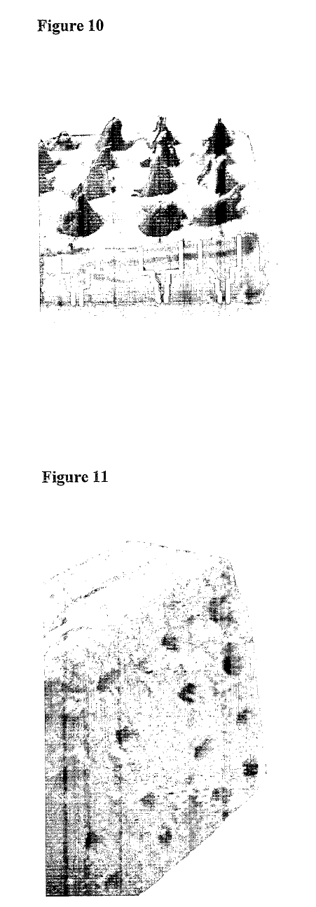

FIG. 10 is a perspective view from above design according the invention, with bulbs, with round supporting gabs

FIG. 11 is a view to the bottom of the design of FIG. 10, with an open (full through) rooting channel with a relative large diameter.

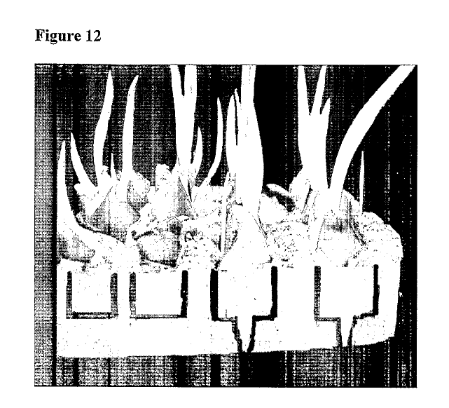

FIG. 12 is a perspective view from above of a design according the invention, with bulbs, where the supportive means are ridges with open, ongoing rooting channels with a large diameter and a stable bulb-planting distance at the 2 right rows, numbered 8 and ridges with open, not ongoing rooting channels and a stable bulb-planting distance at the 2 left rows, numbered 7

FIG. 1A-D shows a design of a device 1, according the invention to grow bulb-crops 4, including a growing substrate 2 and supporting means 3 to tighten the bulbs on the growing substrate of bulb-crops 4 (see FIG. 3) so these bulb-crops 4 roots can develop themselves in the growing substrate 2.

The growing substrate 2 is made from a layer of elastic transformable material. This material is preferred re-usable and/or compostable. This material can be, for example, rock wool or glass wool. This material has an open structure but can hold water, fertilizers and other crop-necessity elements, like fungi or insecticides. Adding vertical channels and the rooting chambers, as described next, can enlarge the porosity. The above-mentioned material is easy to handle. It can be pressed and sawed in specific forms, for instance specially made for growing boxes and/or logistical systems. Other useable materials are for example oasis or rubber-dirt, coco-layers etc.

In the growing substrate 2 gabs/rooting channels 5 are made, which can be used as rooting-chambers or rooting channels for the roots, which will be developed. The model and size of the gabs 5A, D can be can be adjusted to the type of bulb-specie/size 4 and their specific size. The gabs or rooting-chambers 5A, D can be as high as the height of the growing medium 2 (as showed in FIG. 1A and 1D) and therefore open on the bottom-side of the growing substrate 2. This creates the opportunity for water over-supply to run out of the growing medium. On top of this advantage these open channels offers the opportunity to pile up the devices, as this will be presented in the presentation of FIG. 5. An Alternative design can be that the opening on the bottom side 5B, C is closed at the bottom side (As showed in FIG. 1B and 1D. The gabs 5 can be round or be made to a ridge, in which the gabs/rooting-channels 5A-D are vertically positioned on the surface of the drawing. The rooting-channels can have a large diameter (as showed in FIG. 1A and 1C) but can also have a small diameter, as showed in FIG. 1B, D Especially with this last more channels 5B, D can be made/be available for one bulb.

The supporting device 3 contains in FIG. 1 an example of a layer transformable, preferred springy material with additional gabs. These gabs 6 can be, like the blanks 5, have various models/forms in the growing substrate 5. So the gabs can be round and deep or ridge formed, as this will be described with FIG. 2. Also the bottom of the gabs 6, seen in the cross section are egg formed 106, slope formed 306 or rectangular formed 206, as showed in FIG. 6 The positioning of the gabs 6 is always in connection with the gabs 5. Also the sizes and models of the gabs are made such that they can change form, depending on the bulb 4 used. Due to this the bulb 4 will be tightened by the surrounding growing substrate or supportive means.

In the presented model, the growing medium 2 and the supportive means 3 made out of the same piece of material. The transition between these two parts (growing medium 2 and supportive means 3) is presented with an interrupted line.

In FIG. 2A-D the supportive means are showed in a view from above position, with the gabs 6A-D to plant bulbs 4 In FIG. 2A the gabs are round and deep. Other models of these gabs are also possible, square or hexagonal for instance. Also the diameter of the gabs can vary with the depth of the gab. It can become narrower or ball shaped at the bottom, as showed in FIG. 6 (as shown in correspondent nr 306 and 106).

In FIG. 2B-C a second, third and fourth model of a supportive mean 3 are showed in which the open gab 6B-D is presented as a ridge, which can be connected to the rooting chambers 5 in the rooting substrate 2. These rooting chambers 5 can be presented as ridges, but can also be presented as vertically positioned sleeves. In FIG. 2B the ridges 6B are made in the length L of the growing substrate 2, in FIG. 2C in the width B and in FIG. 2C in diagonal direction. Obviously other directions are possible, in which the ridges can be wave or zigzag shaped (not showed). Also the size of the device can vary in the length L and width B and in the height (vertical on the drawing surface). Also the number of gabs 6A-D can vary and therefore the number of bulbs and bulb-crops per m².

In FIG. 3 a cross section from a device 1 is showed with the invention, partly, in which the bulb-crop 4 is locked in the supportive means 3, in such a way that the roots 10 from this bulb 4 can grow into the substrate 2, especially in the rooting chamber 5. This rooting chamber 5 has in the presented drawing a relative large gab on the bottom side of the growing substrate

In FIG. 4 a cross-section is shown with the invention, including a bulb-crop 4 in a conventional bulb-forcing-growing box.

In FIG. 5 is showed how a number of devices can be stacked, in which the bulbs 4 are already planted in the supportive means 3, but the growing substrate 2 is still dry and not watered. As shown, an open gab on the bottom side of the growing substrate 2 brings the advantage for the stem 16 of the underlying growing substrate with a bulb-crop 4 can grow vertically up into the above stacked layer.

FIG. 6 shows a number of possible models for ridges or gabs 6 in the supporting means 3, like egg-shaped 106, square or ball-shaped 206, or with a slope 306, as described above already. Additional on these gabs 6 is a rooting chamber 5, with in this case a large diameter, which is smaller than the diameter of the gabs 106, 206, 306. Due to this specially supporting device “shoulders” 17 are created, which support the bottom of a bulb 4 in a supporting mean 3.

In FIG. 7 an alternative model is showed of a device 101 including the innovation, in which the growing substrate 102 is comparable to one of the previous described models. The supporting mean is in this case replaced by a pin system 103 (see also FIG. 8) with sharp parts 21 where the bulbs can be stacked on. This pin-system can be placed above a growing medium 102, in a way that the roots can enter the specially designed rooting channels 105 in the growing medium 102. With this specially used pin-system the bulbs can be held in position, in this case straight up, unable to be pushed up by the root pressure from the roots or the gravity to drop down. Also other tighting-systems 103 and pin-systems can be used, as showed in FIG. 9 and samples known from the hydro culture systems.

FIG. 10 shows the example of bulbs 4, in this case tulip-bulbs, positioned in a device 1 according tot the invention, in which the supportive means 3 are designed as presented in FIG. 1 and 2, with round sleeve formed gabs 6.

FIG. 11 shows the bottom side of a growing medium 2, manufactured out of rock wool and produced with vertically full open rooting channels, with a relative large diameter.

FIG. 12 shows the example of a device 1, including a bulb-crop 4, in this case tulip-bulbs, in which the supportive means are ridges 6.

Nevertheless the invention is not limited to the descriptions as presented and the examples of the models as showed. All combinations of (parts of) the presented and described models are part of the invention concept. Above all, many variations are possible within the guidelines as presented in the conclusions.

1. Device for growing bulb-crops, including a growing substrate and supporting means, the supporting means are designed to bring and hold the bulbs in a specific position in its contact with the growing substrate, in this the growing substrate must be sturdy enough that after irrigation the original shape will be kept and a good balance between water, air and the basic material and fertilizer is guaranteed, the growing substrate has on the top side, where the bulbs are positioned, gabs to create rooting chambers and rooting channels, to keep and guide the roots developed by the bulbs.

2. Device according to claim 1 in which the gabs have open ends on both sides of the growing substrate.

3. Device according to claim 1 in which the gabs have a sleeve form and where the holes are mostly vertically positioned in the growing medium.

4. Device according to claim 1 in which the gabs have the form of ridges, in which the ridge has in its length during use in most cases a horizontal position.

5. Device according to claim 1, in which the gabs during its use with bulb-crops will have a larger diameter at the top in comparison with the diameter at the bottom side of the gab.

6. Device according to claim 1, in which the supportive means and gabs are positioned in such a way that the roots of the bulbs placed in the supportive means can grow or stretch into the gabs, holes or rooting chambers underneath.

7. Device according to claim 1, in which the supportive means contain a layer of springy material, modified with gabs in such design during use the bulbs are tightened by the springy material.

8. Device according to claim 7, in which the supportive means have the form of a ridge.

9. Device according to claim 7, in which the gabs have the form of a sleeve.

10. Device according to claim 7, in which the gabs have a conical design in the direction of the side of the growing medium.

11. Device according to claim 1, in which the growing medium and the supportive means are made out of the same block of material.

12. Device according to claim 10, in which the change-overs are positioned where the growing medium starts, in which the change-overs are designed to support, for a part, the bulb which is positioned in the supporting means.

13. Device according to claim 1 in which the growing substrate is pressed together to a self-supporting device, useable for transport of the growing substrate including a bulb-crop.

14. Device according to claim 1, in which the growing substrate is made out of mineral wool.

15. Device according to claim 1, in which the growing medium is made out of combinations of fibres and other material which are combined into a growing substrate.

16. Method to raise bulb-crops, like tulips, daffodils or others, including the procedure to: putting bulbs into the growing medium to grow bulbs; and irrigating the growing medium and supplying fertilizer and or other growing supplies, like disinfection's chemicals; in which various steps in use can be separated in time and/or location, and also can be used in a different time span.
